(19) United States
(12) Patent Application Publication
(10) Pub. No.: US 2022/0395107 A1
(43) Pub. Date: Dec. 15, 2022

(54) DUAL-SIDED FOAM MATTRESS WITH LIQUID-RESISTANT AND FIRE-RETARDANT COVER

(71) Applicant: CVB INC., Logan, UT (US)

(72) Inventor: Chase Harris, Logan, UT (US)

(21) Appl. No.: 17/839,743

(22) Filed: Jun. 14, 2022

Related U.S. Application Data
(60) Provisional application No. 63/210,124, filed on Jun. 14, 2021.

(51) Int. Cl. A47C 27/00; A62C 3/00; A47C 31/00; A47C 27/15

(52) U.S. Cl. CPC A47C 27/005; A62C 3/00; A47C 31/001; A47C 27/15

(57) ABSTRACT

A mattress and mattress cover assembly, comprising a mattress component, wherein the mattress component includes a first foam layer having a top side and a bottom side; and a second foam layer, wherein the second foam layer is attached to and extends widthwise and lengthwise across the bottom side of the first foam layer; and a covering completely enclosing the mattress component, wherein the covering includes at least one liquid-resistant layer, wherein the at least one liquid-resistant layer is an outer layer comprising elastic fibers; and at least one fire-retardant layer either attached to or formed integrally with the at least one liquid-resistant layer, wherein the at least one fire-retardant layer is an inner layer comprising fire-retardant fibers.

### CROSS-REFERENCE TO RELATED APPLICATIONS

This patent application claims the benefit of U.S. Provisional Patent Application Ser. No. 63/210,124 filed on Jun. 14, 2021 and entitled “Dual-Sided Foam Mattress with Liquid-Resistant and Fire-Resistant Cover”, the disclosure of which is hereby incorporated by reference herein in its entirety and made part of the present U.S. utility patent application for all purposes.

### BACKGROUND

The disclosed inventive subject matter relates in general to a mattresses and mattress coverings, and more specifically to a roll-compressible mattress and mattress cover assembly that includes a foam mattress enclosed in a single flexible covering that is both water or fluid resistant and fire retardant.

Mattresses that are covered with plastic, vinyl, or other water-resistant materials are common items in hospitals, nursing homes, college dormitories, and some hotels and/or motels. The plastic covering serves an obvious purpose, but can make the covered mattress less than comfortable due to the texture or other characteristics of the plastic being felt through bedding placed on top of it. Furthermore, a plastic covering placed on a mattress having a traditional mattress construction results in water-resistant item that is not easy to store or move due to the relative inflexibility of the materials from which mattresses are typically made. Additionally, if flame or fire retarding properties are desired in addition to waterproofing, a separate fire retardant sock or covering must be placed around the mattress underneath the plastic. The result is a cumbersome and uncomfortable covered mattress that serves its purpose, but that is hardly a desirable item. Accordingly, there is an ongoing need for a more flexible, more portable, and certainly more comfortable mattress having both water-resistant and fire-retardant properties.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One implementation provides a first covering for use with a mattress, comprising at least one liquid-resistant layer; and at least one fire-retardant layer either attached to or formed integrally with the at least one liquid-resistant layer, wherein the at least one liquid-resistant layer and at least one fire-retardant layer are flexible and are configured to cover and enclose a roll-compressible mattress. The covering may further comprise a top portion, a bottom portion, and a sidewall portion disposed between the top portion and the bottom portion. The covering may further comprise a closure extending along the sidewall portion. The at least one liquid-resistant layer may be an outer layer of the covering. The at least one fire-retardant layer may be an inner layer of the covering. The at least one liquid-resistant layer may comprise elastic fibers and the elastic fibers may include polyurethane fibers. The at least one fire-retardant layer may comprise fire-retardant fibers and the fire-retardant fibers may include polyester fibers. The covering may be roll-compressible.

Another implementation provides a second covering for use with a mattress, comprising at least one liquid-resistant layer, wherein the at least one liquid-resistant layer is an outer layer comprising elastic fibers; and at least one fire-retardant layer either attached to or formed integrally with the at least one liquid-resistant layer, wherein the at least one fire-retardant layer is an inner layer comprising fire-retardant fibers. The covering may further comprise a top portion, a bottom portion, a sidewall portion disposed between the top portion and the bottom portion, and a closure extending along the sidewall portion. The elastic fibers may include polyurethane fibers and the fire-retardant fibers may include polyester fibers. The covering may contain 48% polyurethane fibers and 52% polyester fibers. The covering may be roll-compressible.

Still another implementation provides a mattress and mattress cover assembly, comprising a mattress component and a covering for completely enclosing the mattress component. The mattress component includes a first foam layer having a top side and a bottom side; and a second foam layer, wherein the second foam layer is attached to and extends widthwise and lengthwise across the bottom side of the first foam layer. The covering may include at least one liquid-resistant layer, wherein the at least one liquid-resistant layer is an outer layer comprising elastic fibers; and at least one fire-retardant layer either attached to or formed integrally with the at least one liquid-resistant layer, wherein the at least one fire-retardant layer is an inner layer comprising fire-retardant fibers. The top side of the first foam layer may include a plurality of contours formed therein. The first foam layer may include a polyurethane polyol mix and the second foam layer may include a polyurethane polyol mix. The second foam layer may include memory foam having a density of 50 kilograms per meters cubed or 3.1 pounds per square foot. The mattress component may be roll-compressible. The covering may comprise a top portion, a bottom portion, a sidewall portion disposed between the top portion and the bottom portion, and a closure extending along the sidewall portion. The elastic fibers may include polyurethane fibers and the fire-retardant fibers may include polyester fibers. The covering may contain 48% polyurethane fibers and 52% polyester fibers. The covering may be roll-compressible.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### DETAILED DESCRIPTION

Example implementations are now described with reference to the FIGURES. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed inventive subject matter. Accordingly, the following implementations are set forth without any loss of generality to, and without imposing limitations upon, the claimed subject matter.

Implementations of the disclosed system and device provide a mattress and mattress cover assembly that may be used in a variety of physical environments including, but not limited to, dormitories, hospitals, nursing homes, assisted living facilities, and camping environments. The disclosed mattress and mattress cover assembly. The disclosed mattress and mattress cover assembly provides a mattress component that is comfortable, flexible, roll-compressible, and a cover that is both water proof/water resistant and fire-retardant, thereby eliminating the need for a third component (e.g., a dedicated fire-retardant sock disposed between the inner foam layer and the outer layer). Cleaning products of various types may be sprayed directly onto the cover to remove various fluids, thereby making the cover easy to clean by wiping. However, because vinyl is not a component of the disclosed cover, the cover is much more comfortable than similar commercially available products.

An example implementation of the mattress component includes a first foam layer having a top side and a bottom side, wherein the top side includes one or more contours (e.g., cuts, ridges, channels, or other straight or curved features) formed therein; and a second foam layer, wherein the second foam layer is attached to and extends widthwise and lengthwise across the bottom side of the first foam layer; and a covering completely enclosing the mattress component. Other example embodiments do not include contours formed in the top side of the first foam layer. The covering comprises an outer layer that includes a waterproof or water-resistant material and an inner layer that includes a fire-retardant material, wherein the covering comprises a top portion, a bottom portion, and a sidewall portion disposed between the top portion and the bottom portion, and wherein the covering further includes a closure extending along the sidewall portion.

In one example implementation, the mattress component includes a one-sided profiled polyurethane foam layer having a height of about 6.5 inches or about 5.5 inches. The profiled portion includes a plurality of contoured regions cut using computer numerical control (CNC) or otherwise formed therein for achieving desired indentation load deflection (ILD) and providing additional support in certain areas of the mattress. An additional “comfort” layer may be attached to the non-contoured side of the first layer (5.5 inch version). This second layer may have a height of about 1.0 inches and may include memory foam having a density of about fifty (50) kilograms per meters cubed or 3.1 pound per square feet foam. The first foam layer may be a polyurethane polyol mix, and may be manufactured using toluene diisocyanate (TDI). The memory foam layer may be manufactured using methylendiphenyl diisocyanate. Polyurethane foams are typically derived from liquid plastics mixed together with a reagent to produce a ‘closed-cell’ type foam. Depending on the specific type and quantity of polyurethane used, both the firmness and density of the foam can be altered or changed as desired.

Implementations of the covering material include a fabric that includes a 48% polyurethane and 52% polyester mix and that is washable at 90° Celsius or 194° Fahrenheit. As the polyester component is processed, it is mixed with fire-retardant fibers. Fire-retardant polyester exhibits strong durability and breathability, strong elasticity and abrasion resistance, is soft and dries quickly, and when combined with a polyurethane coating, can withstand aggressive chemicals and intense cleaning. The covering may be manufactured in various colors such as, for example, Pantone 446C (charcoal grey) and Pantone 2767C (navy blue). Certain implementations are fire rated to the BS 7175 CRIB 5 standard. Certain implementations are rated for antibacterial and antifungal standards ISO 22196:2011 and AATCC Test Method 30.

In an example manufacturing process, the foam mattress is produced at a first site and the covering is produced at a second site. Both components are send to a third site where they are cut, sewn, and assembled. Once the foam mattress has been cut to size and the cover has been cut and sewn to size, a zipper is installed across the length of three sides of the cover. The zipper allows the cover to be unzipped on one of its short sides so that air can escape as the mattress is roll-compressed and inserted into a cardboard carton. Because the mattress and mattress cover assembly can be roll-compressed, each assembly may be fit into relatively small containers for easier and less expensive shipping to customers. Foam may be sourced from Vitafoam (Romania) or Healthcare Spain (Spain) and the cover may be sourced from Vinteks (Turkey). Other commercial sources in Bulgaria or other countries may be used for providing materials.

The dimensions and weight of variants of a first example implementation are as follows: (a) Twin: 37.5×74×6.5; 26.62 lbs.; (b) Twin XL: 37.5×79×6.5; 28.16 lbs.; (c) Full: 52.5×74×6.5; 36.74 lbs.; and (d) Queen: 59×79×6.5; 43.78 lbs. The dimensions and weight of variants of a second example implementation are as follows: (a) Full XL: 52.5×79×6.5; 38.50 lbs.; (b) King: 74×79×6.5; 51.70 lbs.; (c) Cal King: 71×83×6.5; 50.16 lbs. The dimensions and weight of variants of a third example implementation are as follows: (a) Twin: 37.5×74×6.5; 24.20 lbs.; (b) Twin XL: 37.5×79×6.5; 25.52 lbs. The dimensions and weight of variants of a fourth example implementation are as follows: (a) Full: 52.5×74×6.5; 33.88 lbs.; (b) Queen: 59×79×6.5; 40.70 lbs.; (c) Full XL: 52.5×79×6.5; 36.30 lbs.; (d) King: 74×79×6.5; 49.50 lbs.; (d) Cal King: 71×83×6.5; 47.96 lbs. The dimensions of alternate implementations include: (a) Narrow Twin: 36″×75″; and (b) Narrow Twin XL: 36″×79″. Numerous other dimensions and weights are possible for uses in the hospitality sector, including but not limited to hospitals, KOA Campsites, and hotels/motels.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” used throughout this specification are used to describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A covering for use with a mattress, comprising:
(a) at least one liquid-resistant layer; and
(b) at least one fire-retardant layer either attached to or formed integrally with the at least one liquid-resistant layer,
(c) wherein the at least one liquid-resistant layer and at least one fire-retardant layer are flexible and are configured to cover and enclose a roll-compressible mattress.

2. The covering of claim 1, wherein the covering is roll-compressible and further comprises a top portion, a bottom portion, and a sidewall portion disposed between the top portion and the bottom portion.

3. The covering of claim 2, further comprising a closure extending along the sidewall portion.

4. The covering of claim 1, wherein the at least one liquid-resistant layer is an outer layer of the covering; and wherein the at least one fire-retardant layer is an inner layer of the covering.

5. The covering of claim 1, wherein the at least one liquid-resistant layer comprises elastic fibers, and wherein the elastic fibers comprise polyurethane fibers.

6. The covering of claim 1, wherein the at least one fire-retardant layer comprises fire-retardant fibers, and wherein the fire-retardant fibers comprise polyester fibers.

7. A covering for use with a mattress, comprising:
(a) at least one liquid-resistant layer, wherein the at least one liquid-resistant layer is an outer layer comprising elastic fibers; and
(b) at least one fire-retardant layer either attached to or formed integrally with the at least one liquid-resistant layer, wherein the at least one fire-retardant layer is an inner layer comprising fire-retardant fibers.

8. The covering of claim 7, wherein the covering further comprises a top portion, a bottom portion, a sidewall portion disposed between the top portion and the bottom portion, and a closure extending along the sidewall portion.

9. The covering of claim 7, wherein the elastic fibers comprise polyurethane fibers, and wherein the fire-retardant fibers comprise polyester fibers.

10. The covering of claim 9, wherein the covering contains 48% polyurethane fibers and 52% polyester fibers.

11. The covering of claim 7, wherein the covering is roll-compressible.

12. A mattress and mattress cover assembly, comprising:
(a) a mattress component, wherein the mattress component includes;
(i) a first foam layer having a top side and a bottom side; and
(ii) a second foam layer, wherein the second foam layer is attached to and extends widthwise and lengthwise across the bottom side of the first foam layer; and
(b) a covering completely enclosing the mattress component, wherein the covering includes:
(i) at least one liquid-resistant layer, wherein the at least one liquid-resistant layer is an outer layer comprising elastic fibers; and
(ii) at least one fire-retardant layer either attached to or formed integrally with the at least one liquid-resistant layer, wherein the at least one fire-retardant layer is an inner layer comprising fire-retardant fibers.

13. The mattress and mattress cover assembly of claim 12, wherein the top side of the first foam layer comprises a plurality of contours formed therein.

14. The mattress and mattress cover assembly of claim 12, wherein the first foam layer comprises a polyurethane polyol mix and wherein the second foam layer comprises a polyurethane polyol mix.

15. The mattress and mattress cover assembly of claim 12 wherein the second foam layer comprises memory foam having a density of 50 kilograms per meters cubed or 3.1 pounds per square foot.

16. The mattress and mattress cover assembly of claim 12, wherein the mattress component is roll-compressible.

17. The mattress and mattress cover assembly of claim 12, wherein the covering comprises a top portion, a bottom portion, a sidewall portion disposed between the top portion and the bottom portion, and a closure extending along the sidewall portion.

18. The mattress and mattress cover assembly of claim 12, wherein the elastic fibers comprise polyurethane fibers and wherein the fire-retardant fibers comprise polyester fibers.

19. The mattress and mattress cover assembly of claim 18, wherein the covering contains 48% polyurethane fibers and 52% polyester fibers.

20. The mattress and mattress cover assembly of claim 12, wherein the covering is roll-compressible.
